(19) United States
(12) Patent Application Publication
(10) Pub. No.: US 2026/0087695 A1
(43) Pub. Date: Mar. 26, 2026

(54) COMPACT NORMALIZED HISTOGRAMS AND SCENE CHANGE INDICATOR

(71) Applicant: STMicroelectronics International N.V., Geneva (CH)

(72) Inventors: Olivier Pothier, Sceaux (FR); Thierry Lebihen, Bourg la Reine (FR); Victor Macela, Paris (FR)

(21) Appl. No.: 18/896,121

(22) Filed: Sep. 25, 2024

(51) Int. Cl. G06T 11/20; G01S 7/4865

(52) U.S. Cl. CPC G06T 11/26; G01S 7/4865

(57) ABSTRACT

Direct time-of-flight (dToF) sensor data processing is proposed to address the challenge of efficient scene change detection. In an embodiment, a system comprises a sensor processing circuit and a dToF sensor with a light emitter and photon detector array. The circuit generates compact normalized histograms (CNH) from raw sensor data, performing spatial aggregation across configurable detector zones and temporal accumulation over adjustable periods. Statistical distances between CNH vectors from different time frames are computed using Mahalanobis distance calculations. Scene change indicators are determined by comparing these distances to a threshold derived from a configurable false alarm probability. The approach enables low-power operation, eliminates flicker issues in change detection, and offers flexible trade-offs between spatial-temporal resolution and signal-to-noise ratio. Applications can include presence detection, gesture recognition, and environmental mapping.

### TECHNICAL FIELD

The present disclosure generally relates to electronic devices and, in particular embodiments, to compact normalized histograms and scene change indicators.

### BACKGROUND

Time-of-flight (ToF) sensors have become increasingly prevalent in electronic devices, offering depth sensing, presence detection, and gesture recognition capabilities. The sensors operate by emitting short pulses of light and measuring the time it takes for the light to reflect off objects and return to the sensor. The sensor can determine the distance to objects in its field of view by analyzing the time-of-flight data.

Direct time-of-flight (dToF) sensors are a specific type of ToF sensor that offers accuracy and power efficiency advantages. Rather than continuous wave modulation, dToF sensors emit discrete pulses of light and directly measure the time it takes for each photon to return. This can allow for more precise distance measurements, especially for longer-range objects.

The histogram is a component in processing dToF sensor data. As photons return to the sensor over time, they are typically binned into a histogram representing the distribution of photon arrival times. Analyzing peaks and patterns in the histogram can extract information about object distances and the overall scene. Conventional dToF processing pipelines often focus on detecting discrete object targets from these histograms.

However, detecting changes in a scene over time presents challenges for traditional dToF processing approaches. Statistical noise in the photon detection can lead to flickering effects, where targets may rapidly appear and disappear even in static scenes. This can make it difficult to determine when actual changes have occurred versus when variations are simply due to noise.

Additionally, outputting and processing full raw histogram data from dToF sensors can be bandwidth and computationally intensive. This can limit the feasibility of more advanced histogram analysis, especially on resource-constrained embedded systems.

As applications for dToF sensors expand beyond simple distance measurement to more complex scene understanding tasks, new approaches to extracting richer information from the sensor data are advantageous.

### SUMMARY

Technical advantages are generally achieved by embodiments of this disclosure, which describe compact normalized histograms and scene change indicators.

A first aspect relates to a system for processing direct time-of-flight (dToF) sensor data. The system comprising a dToF sensor comprising a light emitter and a photon detector array; a sensor processing circuit coupled to the dToF sensor and configured to acquire raw photon detection data from the dToF sensor, generate compact normalized histograms (CNH) and corresponding variance vectors from the raw photon detection data, compute statistical distances between CNH vectors from different time frames using the CNH vectors and their corresponding variance vectors, and determine scene change indicators based on the statistical distances; and a host system coupled to the sensor processing circuit and configured to receive the scene change indicators.

A second aspect relates to a method for generating compact normalized histograms (CNH) from direct time-of-flight (dToF) sensor data. The method comprising accessing raw histogram data from a dToF sensor; normalizing the raw histogram data; performing spatial aggregation of the normalized histogram data across configurable detector zones; performing temporal accumulation of the spatially aggregated data over adjustable periods; computing CNH vectors and corresponding variance vectors for each aggregated zone; and outputting the CNH vectors and variance vectors.

A third aspect relates to a method for implementing scene change indication using compact normalized histograms (CNH). The method comprising computing a covariance matrix based on CNH vectors and corresponding variance vectors for current and previous frames; performing matrix inversion on the covariance matrix; computing statistical distances between the CNH vectors of a current frame and a previous frame for each spatial zone; computing a threshold for change detection; computing per-aggregator scene change indicators by comparing the statistical distances to the threshold; and outputting the scene change indicators.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of a direct time-of-flight (dToF) sensing system according to embodiments of the disclosure;

FIG. 2 is a flowchart of an embodiment method for processing direct Time-of-Flight (dToF) sensor data to detect scene changes;

FIG. 3 is a flowchart of an embodiment method for generating Compact Normalized Histograms (CNH) from raw histogram data;

FIG. 4 is an example of the spatial aggregation process for a 4×4 detector array;

FIG. 5 is a flowchart of an embodiment method for implementing a scene change indication process using the Compact Normalized Histogram (CNH) vector and its corresponding variance vector; and

FIG. 6 is an embodiment method for computing a change detection threshold.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of direct time-of-flight (dToF) sensors for presence detection applications, it should also be appreciated that these inventive aspects may also apply to other types of depth sensing technologies and use cases. In particular, aspects of this disclosure may similarly apply to indirect time-of-flight sensors, structured light systems, and other optical sensing methods used for tasks such as gesture recognition, object classification, and environmental mapping.

Embodiments of the disclosure relate to systems and methods for processing data from dToF sensors to enable efficient scene change detection and analysis. These approaches utilize a compact normalized histogram (CNH) representation that can preserve information from raw dToF histograms while significantly reducing data volume. The CNH can be computed by, for example, aggregating and normalizing histogram bins across spatial zones (e.g., three-dimensional spatio-temporal zones) and periods, with configurable parameters to balance spatial-temporal resolution against signal-to-noise ratio.

The disclosed techniques include deriving CNH data directly from dToF sensor outputs, applying optional further compaction steps, and transmitting the resulting compact representation to a host system for additional processing. This can enable bandwidth-efficient transfer of rich histogram information that can be used for advanced scene analysis tasks.

As used herein, “raw photon detection data” refers to the initial output from the photon detector array of the dToF sensor. The data typically includes, for each detected photon, a timestamp indicating the photon's arrival time relative to the emission of the light pulse, and spatial information indicating which element of the photon detector array detected the photon. The raw photon detection data may undergo basic hardware-level processing, such as noise reduction and time-to-digital conversion, but does not include higher-level processing, such as histogram generation, spatial aggregation, or scene change analysis. It represents the earliest stage of data available for software or firmware processing within the sensor system.

Additionally, aspects of the disclosure describe a scene change indication (SCI) algorithm that operates on CNH data to reliably detect changes in the sensor's field of view. The SCI algorithm can compute a statistical distance measure between CNH vectors from different time frames, leveraging known probability distributions to set thresholds for change detection with a specified false alarm rate. This approach mitigates issues with temporal flickering that can affect conventional target-based change detection methods.

The disclosed CNH and SCI techniques can offer a flexible framework tuned for different applications and computational resources. Parameters controlling spatial aggregation, temporal accumulation, and detection sensitivity can be adjusted to optimize performance for specific use cases like presence detection, gesture recognition, or object tracking. The methods can be implemented efficiently in sensor firmware, dedicated hardware, or host processors, enabling low-power operation suitable for always-on sensing applications.

Embodiments of the disclosure can enable new capabilities in fields such as human-computer interaction, ambient intelligence, and computer vision by providing a more robust and efficient way to extract and analyze meaningful information from dToF sensor data. The techniques can be applicable across various applications that can benefit from reliable depth sensing and scene change detection.

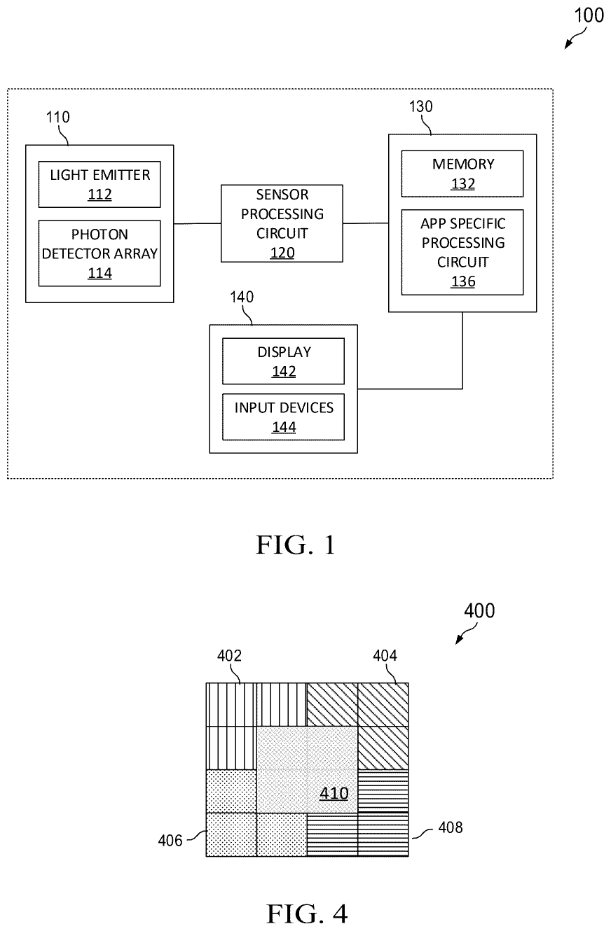

FIG. 1 illustrates a block diagram of a direct time-of-flight (dToF) sensing system 100 according to embodiments of the disclosure. System 100 includes a dToF sensor 110, a sensor processing circuit 120, a host system 130, and a user interface 140, which may (or may not) be arranged as shown. System 100 may include additional components not shown.

The dToF sensor 110 comprises a light emitter 112 and a photon detector array 114. The light emitter 112 can be a laser diode or LED configured to emit short light pulses. The photon detector array 114 may include a plurality of single-photon avalanche diodes (SPADs) arranged in a grid pattern, such as a 4×4 or 8×8 array.

The sensor processing circuit 120 is coupled to the dToF sensor 110 and can perform various processing tasks on the sensor data. It can control the emission of light pulses and synchronize the detection of returning photons. It can construct raw histograms from the detected photon arrival times and process them to produce compact normalized histogram (CNH) data. The processing can include spatial aggregation across detector zones, and bin aggregation and temporal accumulation over multiple periods. The sensor processing circuit 120 can also calculate variance or other statistic information (e.g., higher-order statistics), for the CNH data.

Additionally, the sensor processing circuit 120 can perform optional CNH compaction to reduce data volume further, using techniques such as clipping based on ambient light levels or run-length encoding. The sensor processing circuit 120 can also compute statistical distances between CNH vectors, perform covariance matrix computations and inversions for Mahalanobis distance calculations, and apply thresholds for scene change detection based on configurable false alarm rates.

The sensor processing circuit 120 can include a configuration component that allows the adjustment of various system parameters, including aggregation zone definitions, bin aggregation techniques, accumulation periods, and detection thresholds. It can also incorporate power management capabilities to enable low-power “sleep mode” operation for always-on sensing scenarios.

The implementations of these processing tasks within the sensor processing circuit 120 can be realized through hardware (e.g., dedicated logic circuits, FPGAs), software running on a microprocessor or microcontroller, or a combination of hardware and software, depending on the specific application requirements and design constraints.

The host system 130 is coupled to the sensor processing circuit 120 and can be a general-purpose processor or application-specific integrated circuit. The host system 130 includes memory 132 for storing CNH data, variance or other statistical information, and intermediate processing results. It may also include additional application-specific processing capabilities that utilize the CNH or scene change detection outputs for higher-level tasks.

The user interface 140 is coupled to the host system 130 and can include a display 142 for presenting visual feedback and one or more input devices 144 such as buttons, touchscreens, or gesture sensors. The user interface 140 allows users to interact with applications leveraging dToF sensing capabilities.

In some embodiments, the sensor processing circuit 120 and host system 130 may be integrated into a single chip or package. In embodiments, the components are implemented as separate devices with a high-speed interface. The specific partitioning of functionality between the sensor processing circuit 120 and host system 130 can vary depending on the application requirements and available computational resources.

System 100 can be integrated into various electronic devices that benefit from ToF sensing capabilities. These devices include but are not limited to, laptops, tablets, smartphones, and other portable consumer electronics. The system can also be implemented in smart home devices such as security cameras, doorbells, or occupancy sensors. System 100 may be incorporated into robotics, automated manufacturing equipment, or inventory management systems in industrial settings. Additionally, the system 100 is suitable for automotive applications, potentially enhancing driver assistance systems or in-cabin monitoring.

The flexibility and efficiency of system 100 make it adaptable to various form factors and power constraints, allowing it to be integrated into both battery-powered devices and mains-powered equipment. The versatility enables applying advanced scene change detection and presence sensing across a broad spectrum of consumer, industrial, and automotive products.

A challenge stems from limitations in conventional dToF sensor processing approaches, particularly the traditional Histogram Pipe (HIP) method. Histogram Pipe (HIP) is a standard processing method in many dToF sensor systems. In the HIP approach, the dToF sensor emits short pulses of light and measures the time it takes for the pulses to reflect off objects and return to the sensor. Photons are detected and binned into a histogram based on their arrival times. This histogram represents the distribution of photon arrival times and the scene in front of the sensor.

The HIP function analyzes the histograms to detect discrete object targets and estimate their distances from the sensor. It does this by identifying histogram peaks corresponding to concentrations of returned photons. The timing of the peaks relative to the emitted light pulse can be used to calculate the distance to the reflecting objects. The approach can be particularly effective for detecting simple, planar targets in straightforward environments, such as in autofocus assist in mobile phones.

However, the conventional HIP processing approach for dToF sensors can encounter several challenges that limit its effectiveness in certain applications. While the HIP excels at detecting simple, planar targets and estimating their distances, it struggles in more complex scenarios.

One issue with the HIP is its difficulty in handling specific environmental conditions. For example, the HIP's performance can degrade significantly when dealing with specular targets, slanted surfaces, or intricate scenes. The limitations can result in inaccurate or inconsistent distance measurements, potentially compromising the reliability of applications that rely on precise depth information.

Another drawback of the HIP is its inability to effectively detect changes in the scene between two time instants. The limitation can become particularly problematic in applications such as presence detection or motion sensing, where identifying temporal environmental variations is advantageous. The HIP's focus on individual target detection rather than overall scene analysis can lead to missed or false detections of environmental changes.

Further, the use of HIP outputs for presence detection applications can often be unreliable due to temporal effects in the target detection process. The effects, known as flicker effects, arise from the statistical nature of the HIP's pulse detection process, which deals with photon noise signals. The flicker can cause targets to appear rapidly and disappear even in static scenes, making distinguishing between genuine presence events and noise-induced fluctuations challenging.

The limitations of the HIP become even more apparent in specific, more complex use cases, such as coffee cup detection or detailed object analysis. These scenarios often require a more in-depth examination of the dToF sensor's bin-level signal, which the HIP is not designed to provide. As a result, valuable information that could be extracted from a more granular sensor data analysis is often lost or overlooked.

Lastly, while potentially informative, the direct output of entire histogram bins for offline processing presents its challenges. The approach is highly bandwidth and throughput-intensive, making it impractical for many real-time or resource-constrained applications. Additionally, raw histogram data often contains redundancies and extraneous information, further complicating efficient processing and analysis.

These limitations of the conventional HIP approach highlight the need for alternative approaches to address these challenges while maintaining or improving the strengths of dToF sensing technology.

Several approaches have been developed to address the limitations of the conventional HIP method, particularly in presence detection and scene change analysis. While these solutions offer some improvements, they also come with their own set of challenges and limitations.

One approach attempts to mitigate the flicker issue inherent in HIP-based systems. The solution employs a complex state machine and multiple algorithms to filter out false detections caused by temporal instabilities in the target detection process. While this method can reduce some flicker-related errors, it introduces computational complexity and power consumption. The increased processing requirements can be problematic for resource-constrained devices or applications demanding low-power operation. Additionally, certain corner cases remain unhandled, leading to performance limitations in some scenarios.

Other basic solutions for change detection rely on comparing raw signals from active infrared sensors or similar technologies. These methods typically involve subtracting consecutive frames of sensor data to identify differences that might indicate movement or changes in the scene. However, these approaches often struggle with range limitation, making it difficult to constrain detection to a specific distance range (e.g., 0 to 1.5 meters). They are also highly susceptible to noise, including variations caused by changes in ambient illumination. The sensitivity to noise can lead to false positives, reducing the reliability of the change detection system.

Further, these basic differencing methods are limited in performance tuning. Striking the right balance between detection sensitivity and system stability often requires careful adjustment of thresholds and hysteresis parameters. The tuning process can be time-consuming and may need to be repeated for different environmental conditions, limiting the system's versatility.

An alternative approach involves outputting the entire set of histogram bins from the dToF sensor for offline processing. This method allows for more sophisticated analysis of the raw sensor data, potentially enabling more accurate change detection and scene understanding. However, this approach has drawbacks regarding data throughput and bandwidth requirements. Transmitting and processing the full histogram data can be prohibitively intensive, especially for systems with limited computational resources or power budgets.

Moreover, the raw histogram data often contains redundant or irrelevant information. The excess data not only increases processing overhead but can also complicate the extraction of meaningful insights. The challenge of separating signal from noise becomes more pronounced when dealing with large volumes of raw data.

Another limitation of the full histogram output approach is bypassing the potential benefits of low-level, sensor-side processing. Valuable operations such as crosstalk removal and ambient noise estimation and subtraction, which can be efficiently performed at the sensor level, are not leveraged in this method. As a result, the downstream processing must handle these tasks, potentially reducing overall system efficiency.

While these existing solutions address some aspects of the HIP limitations, they still allow improvement in efficiency, accuracy, and adaptability to diverse sensing scenarios. Accordingly, an approach that balances computational efficiency with robust scene change detection and analysis capabilities is advantageous.

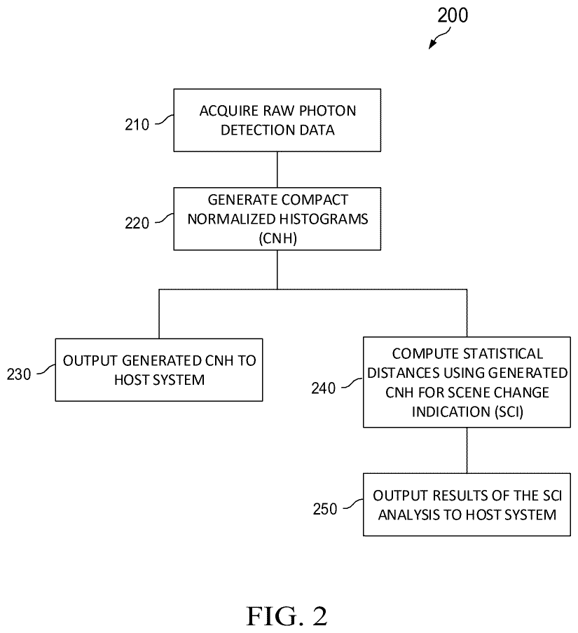

FIG. 2 illustrates a flowchart of an embodiment method 200 for processing direct Time-of-Flight (dToF) sensor data to detect scene changes. Method 200 provides a high-level overview of the process, focusing on generating Compact Normalized Histograms (CNH) and their use in Scene Change Indication (SCI).

It is noted that all steps outlined in the flow chart of method 200 are not necessarily required and can be optional. Further, changes to the arrangement of the steps, removal of one or more steps and path connections, and addition of steps and path connections are similarly contemplated.

At step 210, the sensor processing circuit 120 acquires raw photon detection data from the dToF sensor 110. In embodiments, the sensor processing circuit 120 performs several operations to generate raw histograms from the photon detection data. As the dToF sensor 110 emits light pulses via the light emitter 112, the photon detector array 114 captures the reflected photons. The sensor processing circuit 120 then records the arrival times of these photons relative to the emission of the light pulse.

In embodiments, the sensor processing circuit 120 divides the possible photon arrival times into discrete time bins to construct the raw histograms. Each detected photon is assigned to a bin based on its arrival time. The circuit counts how many photons fall into each time bin, creating a histogram of photon arrival times.

The process is typically repeated over multiple light pulse cycles to accumulate enough data for a statistically significant histogram. The number of cycles and the duration of each cycle can be configurable parameters, allowing the system to balance temporal resolution and signal strength.

For multi-zone sensors, the sensor processing circuit 120 may generate separate histograms for each zone or group of zones in the photon detector array 114. The spatial information can be preserved in the raw histogram data, enabling subsequent processing steps to perform spatial analysis or aggregation as needed. The resulting raw histograms represent the distribution of photon arrival times across the sensor's field of view.

At step 220, the sensor processing circuit 120 processes the raw histogram data to generate Compact Normalized Histograms (CNH). This step can involve spatial aggregation of histogram bins across configurable detector zones, bin aggregation within the very histograms, temporal accumulation over adjustable periods, and normalization of the aggregated data. In embodiments, the sensor processing circuit 120 calculates variance or other statistical information for the normalized histograms. The resulting CNH data and associated variance or other statistical information can be stored in memory 132 of the host system 130.

Step 230 involves a first option for using the generated CNH data, where the CNH data is output directly from the sensor processing circuit 120 to the host system 130 for use in various applications. This can include transmitting the compact representation for further processing or analysis by application-specific processing circuit 136.

In embodiments where the intended use is to output the CNH from the sensor processing circuit 120 to the host system 130, the process can conclude at this stage. This option can be useful for scenarios requiring further ad-hoc or AI-based processing on the host system 130. Further, in cases where additional compactification is to be performed on the sensor firmware side, reverse operations can be handled by the host system 130. These operations may include Run-Length (RL) decoding to expand compressed data, synthetic ambient noise generation and addition (for which the ambient level is transmitted alongside the CNH data), and other decompression or reconstruction techniques as needed. This flexibility allows for efficient data transmission while preserving the ability to recover more detailed information at the host level for sophisticated analysis or machine learning applications.

Step 240 involves a second option for using the generated CNH data, where the CNH data is used for Scene Change Indication (SCI). In embodiments, the sensor processing circuit 120 computes statistical distances between CNH vectors from different time frames stored in memory 132, using techniques such as the Mahalanobis distance. The covariance matrix computation can assist in this calculation. In embodiments, the computed distances are compared against thresholds derived from desired false alarm probabilities to determine if a significant scene change has occurred.

For step 240, the sensor processing circuit 120 or the application-specific processing circuit 136 provides the results of the SCI analysis, which may include binary indicators of scene change for different spatial zones. The host system 130 can use this output for higher-level applications or send results to the display 142 of the user interface 140.

Method 200 can be implemented as a continuous loop, with the sensor processing circuit 120 continuously processing new sensor data from the dToF sensor 110 in real-time. In embodiments, the sensor processing circuit 120 allows dynamic adjustment of parameters such as aggregation zones, accumulation periods, and detection thresholds based on inputs from the host system 130 or input devices of the user interface 140.

Method 200 provides a framework for efficient and flexible processing of dToF sensor data. It offers improvements over conventional HIP approaches regarding data compactness, scene change detection capability, and adaptability to different use cases.

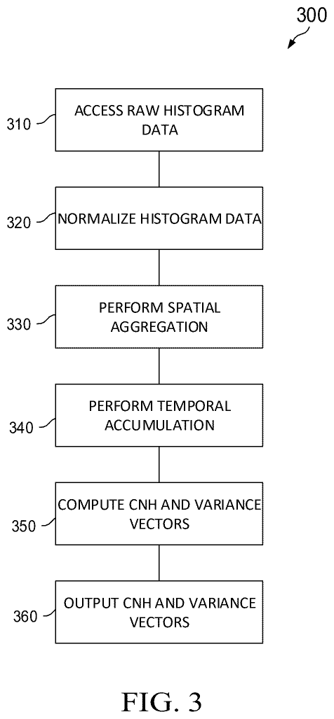

FIG. 3 illustrates a flowchart of an embodiment method 300 for generating Compact Normalized Histograms (CNH) from raw histogram data. Method 300 can be implemented as step 220 in FIG. 2.

It is noted that all steps outlined in the flow chart of method 300 are not necessarily required and can be optional. Further, changes to the arrangement of the steps, removal of one or more steps and path connections, and addition of steps and path connections are similarly contemplated.

At step 310, the sensor processing circuit 120 accesses the raw histogram data generated in step 210 of method 200. The raw histogram data includes photon counts for each time bin across multiple zones of the photon detector array 114, constructed from the photon arrival times detected by the dToF sensor 110.

At step 320, the sensor processing circuit 120 normalizes the raw histogram data. The normalization process is performed before aggregation or accumulation to ensure that subsequent operations work with comparable data across different zones and timing modes.

In embodiments, the sensor processing circuit 120 estimates and subtracts the ambient light level from each histogram bin. The ambient light estimation can be performed by analyzing the histogram bins outside the expected range of the emitted light pulse returns. The bins typically contain only ambient light detections. The estimated ambient light level is subtracted from all bins, helping to isolate the signal of interest (i.e., the reflected light pulse) from background noise.

The data can be normalized based on the number of effective SPADs (Single-Photon Avalanche Diodes) in each zone. This normalization accounts for potential variations in detector sensitivity across the array. The number of effective SPADs can vary due to manufacturing variations or intentional deactivation of some SPADs to reduce power consumption or avoid signal saturation in high-light conditions. The normalization process divides the photon count in each bin by the number of effective SPADs in its corresponding zone, resulting in a per-SPAD photon count comparable across different zones.

The data can be normalized based on the duration of the acquisition time. Normalization can be advantageous when data from different timing modes are combined for varying durations. For example, if one timing mode collects data for 100 microseconds and another for 200 microseconds, the photon counts from the longer acquisition would be divided by two to make them comparable to the shorter acquisition. This results in a photon count rate (counts per unit time) rather than an absolute count, allowing fair comparison and combining data from different timing modes.

The normalization formula can be expressed as

$$NORMALIZED\_COUNT = \frac{RAW\_COUNT - AMBIENT\_ESTIMATE}{NUM\_EFFECTIVE \_SPADS \times TIME\_ACQUISITION} ,$$

where RAW_COUNT is the original photon count in a bin, AMBIENT_ESTIMATE is the estimated ambient light level, NUM_EFFECTIVE_SPADS is the number of active SPADs in the zone, and TIME_ACQUISITION is the duration of data collection for that timing mode.

At step 330, the sensor processing circuit 120 performs spatial aggregation of the normalized histogram data. The circuit combines data from multiple detector zones based on a configurable aggregation map. For example, in a 4×4 array, certain zones may be grouped to form larger aggregate areas. This step allows for flexibility in balancing spatial resolution against signal-to-noise ratio.

The spatial aggregation process offers flexibility in balancing spatial resolution (X, Y) against signal-to-noise ratio (SNR). The system can adapt to different scene conditions and application requirements by allowing configurable aggregation of detector zones. Smaller aggregate areas provide higher spatial resolution, enabling the detection of finer details in the scene. However, this comes at the cost of lower SNR, as each aggregate area contains fewer photon counts. Conversely, larger aggregate areas improve SNR by combining more photon counts, but at the expense of spatial resolution. This flexibility allows the system to optimize performance for various scenarios, such as detecting small objects in well-lit environments (favoring spatial resolution) or identifying larger movements in low-light conditions (prioritizing SNR).

At step 330, the sensor processing circuit 120 performs spatial aggregation of the normalized histogram data. The circuit combines data from multiple detector zones based on a configurable aggregation map. For example, in a 4×4 array, certain zones may be grouped to form larger aggregate areas. This step allows for flexibility in balancing spatial resolution against signal-to-noise ratio.

The spatial aggregation process offers flexibility in balancing spatial resolution (X, Y) against signal-to-noise ratio (SNR). The system can adapt to different scene conditions and application requirements by allowing configurable aggregation of detector zones. Smaller aggregate areas provide higher spatial resolution, enabling the detection of finer details in the scene. However, this comes at the cost of lower SNR, as each aggregate area contains fewer photon counts. Conversely, larger aggregate areas improve SNR by combining more photon counts, but at the expense of spatial resolution. This flexibility allows the system to optimize performance for various scenarios, such as detecting small objects in well-lit environments (favoring spatial resolution) or identifying larger movements in low-light conditions (prioritizing SNR).

In embodiments, the aggregation map is defined in the algorithm configuration files. The aggregation map can be used to determine how individual zones in the detector array are grouped. In an embodiment, the aggregation map assigns unique identifiers to different groups of zones.

For example, in a 4×4 array, the 16 zones can be grouped into four larger aggregate areas, each identified by a number (1, 2, 3, 4, etc.). The aggregate ID map can be more complex, allowing for non-rectangular shapes or varying sizes of aggregate areas, such as five aggregate areas of different shapes and sizes.

The sensor processing circuit 120 can use this map to combine the histogram data from all zones sharing the same identifier. In embodiments, the sensor processing circuit 120 sums the histogram data for all zones within each aggregate area, creating a single, combined histogram for each unique identifier in the aggregation map. The aggregation process can significantly reduce the data processed in subsequent steps while preserving spatial information at a coarser scale.

In embodiments, the aggregation map can be dynamically updated based on application requirements or environmental conditions, allowing the system to adapt its spatial resolution as needed.

Step 340 involves the temporal accumulation of the spatially aggregated data. The sensor processing circuit 120 can combine histogram data from multiple time frames or light pulse cycles. The number of frames to accumulate can be a configurable parameter, allowing the system to adjust the trade-off between temporal resolution and signal strength.

Step 340 introduces flexibility in balancing temporal resolution against SNR through adjustable temporal accumulation. The number of frames or light pulse cycles combined can be configured based on the application's specific requirements or the current environmental conditions. Accumulating data from more frames increases the SNR by effectively collecting more photons over a longer period, which can be beneficial in low-light situations or when detecting subtle changes. However, this comes at the cost of reduced temporal resolution, as changes occurring between accumulated frames may be averaged out. Conversely, accumulating fewer frames provides better temporal resolution, allowing the system to detect rapid changes in the scene but at the expense of lower SNR. The adaptability enables the system to optimize its performance for various use cases, from detecting fast movements in well-lit environments to identifying slow changes in challenging lighting conditions.

In embodiments, the sensor processing circuit 120 combines data from multiple timing modes (e.g., timing A and timing B) for each frame. For each aggregate area defined in step 330, the sensor processing circuit 120 computes a feature vector. The feature vector can be created by performing a subsum on the histograms from the different timing modes.

A subsum in the context of CNH generation refers to a technique used to reduce the dimensionality of the raw histogram data while preserving essential information. In this process, adjacent bins in the original histogram are grouped, and their values are combined, typically through addition. For example, if a subsum spans three bins, the values of three consecutive histogram bins would be added to create a single value in the resulting CNH. The process effectively reduces the number of bins in the histogram, compressing the data while maintaining the original distribution's overall shape and features.

The subsuming process can involve aligning the histograms from the timing modes based on a common reference point, such as the start bin of the latest reference pulse; defining a set number of subsums (e.g., 21 subsums) that will form the elements of the feature vector; combining a specified number of bins from the aligned histograms for each subsum; normalizing the subsums based on factors such as the number of effective SPADs and the acquisition time for each timing mode; or a combination thereof. The resulting feature vector represents a compact form of the histogram data for each aggregate area, incorporating information from multiple timing modes and multiple bins.

The process can be repeated for each frame, allowing for the accumulation of data over time. The number of frames to accumulate can be configurable, allowing the system to balance between increased signal-to-noise ratio (with more frames) and better temporal resolution (with fewer frames).

The number of bins to be combined into each subsum can be configurable, allowing flexibility in balancing data compression against preservation of detail. Using subsums, the sensor processing circuit 120 can significantly reduce the amount of data to be processed and stored while retaining enough information for accurate scene change detection and analysis.

At step 350, the CNH vector and its corresponding variance vector; or other statistical information vector, for each zone are computed. The computation of the CNH vector offers flexibility in balancing depth resolution (i.e., Z dimension) against SNR. By adjusting the number of subsums and the sum span (i.e., the number of bins per subsum), the sensor processing circuit 120 can optimize the trade-off between these two factors. A larger sum span combines more bins, increasing SNR by accumulating more photon counts, but at the cost of reduced depth resolution. Conversely, a smaller sum span preserves finer depth details but may result in lower SNR, especially in low-light conditions or for distant objects. The number of subsums determines the overall range and granularity of the depth measurement. More subsums can provide a wider or more finely segmented depth range, while fewer subsums can focus on a specific depth range of interest with potentially improved SNR. This flexibility allows the system to adapt to various scenarios, such as detecting fine depth variations in well-lit, close-range environments or reliably identifying larger depth changes in challenging, long-range conditions.

In an embodiment, the sensor processing circuit 120 computes a CNH vector and a corresponding variance vector for each zone. The CNH vector elements (F_{i,t}) can be calculated using the formula:

$${F}_{i , t} = \frac{1}{{C}_{1}} ( ( {\sum }_{K = 1}^{sumspan} {H}_{REF\_PULSE \_START + ( i - 1 ) \times sumspan + K} ) - \hat{A} \times sumspan ) ,$$

where C₁ is a first normalization constant, H represents the histogram values, REF_PULSE_START is the start bin of the latest reference pulse, sumspan is the number of bins per subsum, and Â is the estimated ambient light per bin. Here, i represents the index of the subsum within the CNH and corresponding variance vectors (i can range from 1 to the total number of subsums) and t represents the time frame or temporal index indicating the computed frame of data for the CNH and corresponding variance vectors.

The variance vector elements (VAR_{i,t}) can be computed using the formula:

$${VAR}_{i , t} = \frac{1}{{C}_{2}} ( {F}_{i , t} + \hat{A} + sumspan + var ( \hat{A} ) \times {sumspan}^{2} ) ,$$

where C₂ is a second normalization constant and var(Â) is the variance of the estimated ambient light.

This approach allows the system to adapt to different depth ranges and noise conditions while providing statistical information for subsequent analysis steps. The number of subsums and the sum_span (number of bins per subsum) can be adjusted to optimize performance for different depth ranges and noise conditions.

In embodiments, the sensor processing circuit 120 applies additional compaction techniques to the histogram data to reduce data volume while preserving information. One method for achieving this is bin summation. In this process, the sensor processing circuit 120 combines adjacent time bins in the histogram, effectively reducing the total number of bins. For example, if the original histogram has 1000 bins, the compaction process might combine every two adjacent bins, resulting in a new histogram with 500 bins. The combination can be performed by adding the normalized photon counts from the adjacent bins.

The number of bins to be combined can be configurable, allowing the system to adjust the level of compaction based on application requirements. The flexibility enables a balance between data reduction and preservation of temporal resolution. For example, fewer bins might be combined in scenarios where fine time-of-flight measurements are advantageous. Conversely, more aggressive bin summation can be applied to achieve greater data reduction in applications where broader changes are of interest.

Additionally, the bin summation process can be non-uniform across the histogram. For example, bins corresponding to distances of greater interest might undergo a less aggressive combination, preserving more detail in those regions. In contrast, bins representing less critical distances could be more heavily compacted. The adaptive approach can allow the system to maintain high resolution where it matters most while still achieving significant data reduction overall.

The compaction process reduces data volume, which is beneficial for storage and transmission efficiency, and can also improve the signal-to-noise ratio in each resulting bin. By combining multiple bins, random noise averages out, potentially making the signal of interest more prominent. However, this comes at the cost of reduced temporal (and thus depth) resolution, illustrating the trade-off between data reduction, SNR improvement, and resolution preservation.

In embodiments, the sensor processing circuit 120 employs an additional optional compaction technique called clipping. Clipping involves setting an upper threshold for histogram bin values, above which all values are “clipped” or set to the threshold value. The clipping threshold can be configurable, allowing the system to adjust the level of compaction based on specific application needs or environmental conditions.

The purpose of clipping is to reduce data volume further and eliminate noise or outliers in the histogram data. By imposing an upper limit on bin values, the range of possible values that need to be represented can be reduced, leading to more efficient data encoding and storage. For example, if the original histogram values range from 0 to 1000, but most significant information is contained in values below 500, a clipping threshold could be set at 500. All values above 500 would be set to 500, effectively reducing the range of values that need to be represented.

Clipping can be particularly effective in scenarios with high dynamic range, where a few bins might have exceptionally high values due to strong reflections or noise spikes. By clipping these high values, the overall dynamic range of the histogram is reduced, which can make subsequent processing steps more robust and potentially improve the visibility of weaker signals.

However, the clipping process must be applied judiciously, as it can potentially remove valid data and noise. The configurable nature of the clipping threshold can allow the system to balance between aggressive noise reduction and preservation of potentially important high-intensity signals. In embodiments, the clipping threshold might be dynamically adjusted based on factors such as ambient light levels, estimated signal strength, or specific features of interest in the scene.

Further, more sophisticated clipping strategies can be employed. For example, a soft clipping approach might gradually compress values as they approach the threshold instead of a hard threshold, providing a more nuanced treatment of high-intensity signals. Alternatively, adaptive clipping techniques could apply different thresholds to histogram regions based on local statistics or expected signal characteristics.

Combining clipping with compaction techniques like bin summation, the sensor processing circuit 120 can reduce data volume while preserving the most critical information for subsequent analysis and scene change detection.

It should be appreciated that other techniques to compact the normalized histogram data further can be used, such as logarithmic-based compression curves, Run-Length Encoding (RLE), or the like. The additional compaction methods can be employed alongside or instead of the bin summation and clipping techniques, depending on the specific requirements of the application and the nature of the histogram data. The choice of compaction technique can be made based on factors such as the desired compression ratio, the importance of preserving certain data features, and the computational resources available for decompression during subsequent processing steps.

In addition to generating the CNH vectors, the sensor processing circuit 120 can extract further features from the CNH vectors. The additional features can provide information about the shape and characteristics of the histogram data. For example, the sensor processing circuit 120 can identify the start and end points of meaningful regions within the CNH, which may correspond to significant objects or surfaces in the scene.

In embodiments, sensor processing circuit 120 can compute statistical measures such as kurtosis, which describes the “tailedness” of the distribution and can indicate the presence of outliers or distinct peaks in the histogram. Other shape-related features might include measures of skewness, the number and locations of local maxima, or the width of primary peaks.

The additional features can be used to enrich the scene representation, improving the accuracy of change detection or enabling more sophisticated scene analysis tasks. The specific set of additional features extracted can be configurable based on the requirements of downstream processing steps or the particular application needs.

At step 360, the sensor processing circuit 120 outputs the Compact Normalized Histograms (CNH) and their associated variance information, or other associated statistical information. The data can then be stored in the memory 132 of the host system 130 for further processing or analysis.

The CNH generation process offers several key advantages and features. The resulting CNH is compact and flexible, allowing for efficient data representation while accommodating various processing needs. The process includes corrections for ambient light noise and subtraction of crosstalk (such as coverglass return), enhancing the signal quality.

In embodiments, the system provides a variable range detectability limit, which can be adjusted to ignore far-scene changes that may not be relevant to the application. This feature allows for focus on the most pertinent depth ranges.

Further, the CNH generation offers a variable trade-off between SNR and resolution across multiple dimensions (X, Y, Z, and time). This flexibility optimizes the system for different use cases and environmental conditions.

The proposed process ensures that the CNHs follow a known probability law, typically a Poisson or Gaussian distribution. The system can derive each computing step's characteristic mean and variance estimates. The statistical rigor enhances the reliability of subsequent change detection algorithms. It allows for the optional output of the CNH's estimated variance, providing additional information for downstream processing or analysis tasks.

Method 300 can be implemented as a continuous process within the sensor processing circuit 120, with parameters such as aggregation zones, accumulation periods, and compaction techniques dynamically adjustable based on application requirements or environmental conditions.

FIG. 4 illustrates an example of the spatial aggregation process for a 4×4 detector array 400, demonstrating how individual zones can be grouped into larger aggregate areas. This grouping allows for flexibility in balancing spatial resolution against SNR. In this example, the 4×4 detector array 400 is divided into five distinct aggregate areas, each represented by a different shading. The aggregation scheme reduces the original 16 zones to 5 larger areas, showcasing how the system can adapt to different requirements across the field of view.

Four aggregate areas, located in the corners of the array, each combine three zones. Different shadings represent these: the first aggregate area 402 is located in the top left, the second aggregate area 404 is located in the top right, the third aggregate area 406 is located in the bottom left, and the fourth aggregate area 408 is located in the bottom right. Each area merges three adjacent zones, creating larger detection regions that can improve SNR at the cost of some spatial resolution.

The fifth aggregate area, 410, located in the center of the 4×4 detector array 400, combines four zones. The central area creates the largest single detection region in this configuration.

As described in method 300, the aggregation map can be used by the sensor processing circuit 120 to combine the histogram data from all zones within each aggregate area, creating a single, combined histogram for each of the five uniquely shaded regions. By reducing the number of effective detection areas from 16 to 5, the approach allows the system to improve SNR across the entire field of view, while still maintaining some level of spatial differentiation.

The flexible aggregation scheme demonstrates how the system can adapt to different requirements, optimizing the trade-off between spatial resolution and SNR based on the application's specific needs. It could be particularly useful in scenarios where general movement detection or presence sensing is more important than fine spatial detail across the entire field of view.

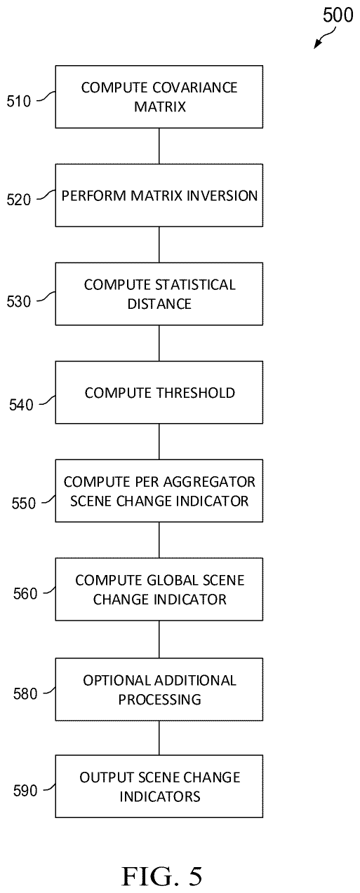

FIG. 5 illustrates a flowchart of an embodiment method 500 for implementing a scene change indication process using the Compact Normalized Histogram (CNH) vector and its corresponding variance vector. Method 500 can be implemented as step 240 in FIG. 2.

It is noted that all steps outlined in the flow chart of method 500 are not necessarily required and can be optional. Further, changes to the arrangement of the steps, removal of one or more steps and path connections, and addition of steps and path connections are similarly contemplated.

Step 510 involves computing a covariance matrix based on the CNH and variance vectors for the current and previous frames from memory 132. The vectors represent the compact, normalized histogram data for different spatial zones of the sensor array.

The covariance matrix captures the variances of individual elements in the vector D_{CNH} corresponding to the difference of successive CNH vectors and the relationships (covariances) between different elements thereof.

The covariance matrix is a component for a Mahalanobis distance calculation performed in step 540. It captures the variances of individual elements in the CNH difference vector D_{CNH} and the covariances between its elements, effectively describing the statistical relationships within the data. By computing this matrix, the sensor processing circuit 120 prepares the necessary statistical information to accurately assess the magnitude of changes between frames, considering the inherent variability and correlations in the CNH data.

In embodiments, the sensor processing circuit 120 starts with the variance vectors for the current and previous frames to construct the covariance matrix. These variance vectors contain the variance estimates for each element of the CNH vectors. The diagonal elements of the covariance matrix of D_{CNH} are populated based on these variance values, representing the variability of each CNH element.

For the off-diagonal elements representing the covariances between different D_{CNH} elements, the sensor processing circuit 120 may employ various computation/estimation techniques. One simplified approach can be to assume independence between different elements of D_{CNH}, setting off-diagonal terms to zero. However, the system might compute/estimate covariances based on historical data or theoretical models of the sensor's behavior for more accurate results.

The resulting covariance matrix is symmetric and positive semi-definite, properties that are used for the subsequent Mahalanobis distance calculation. This matrix encapsulates the full statistical relationship between different elements of the D_{CNH} vector, allowing the Mahalanobis distance to account for the variances of individual elements and their inter-dependencies when assessing the magnitude of changes between frames.

At step 520, the sensor processing circuit 120 performs matrix inversion on the covariance matrix computed in step 510. The matrix inversion process transforms the covariance matrix Σ into inverse Σ⁻¹ to properly weigh the differences between D_{CNH} vector elements based on their variances and covariances. In an embodiment, the inverse matrix elements are directly computed based on offline determined formulas, skipping the direct matrix computation and its inversion.

This step, along with the covariance matrix computation in step 510, sets the stage for the Mahalanobis distance computation, providing a statistically robust measure of change between the current and previous frames for each spatial zone.

Given that the covariance matrix is symmetric and positive semi-definite, specialized inversion techniques for such matrices can be applied to improve efficiency and numerical stability. In some cases, if the matrix is ill-conditioned or near-singular, regularization techniques may be applied before inversion to ensure a stable result.

The inverted matrix Σ⁻¹ scales and rotates the difference vector D_{CNH} between the current and previous CNH vectors, accounting for the data's variability and correlations. This allows the Mahalanobis distance to provide a more statistically meaningful measure of change than simpler distance metrics that don't consider the data's covariance structure.

In embodiments with limited computational resources, approximations or updates to the inverted covariance matrix can be used instead of full re-computation for every frame, trading some accuracy for improved processing speed.

At step 530, the sensor processing circuit 120 computes a statistical distance between the CNH vectors of the current frame and the previous frame (i.e., different instants) for each spatial zone (i.e., areas defined by the spatial aggregation process) from the covariance matrix computed at step 510 and the matrix inversion performed at step 520.

Although the distance calculation can be performed using various techniques, the Mahalanobis distance is employed in an embodiment. The Mahalanobis distance considers the variance information, providing a robust measure of change that considers the statistical properties of the data. The Mahalanobis distance (d(\vec{x},\vec{y})) can be represented using the equation

$$d ( \vec{x} , \vec{y} ) = \sqrt{{( \vec{x} , \vec{y} )}^{T} {Σ}^{- 1} ( \vec{x} , \vec{y} )} ,$$

where \vec{x} represents the CNH vector of the current frame, \vec{y} represents the CNH vector of the previous frame, and Σ is the covariance matrix computed from the variance vectors associated with these CNH vectors.

For systems with limited computational resources, the sensor processing circuit 120 can employ specific variable fixed-point computation techniques to handle the distance computation on a CPU without a floating-point unit. This optimization enables efficient processing even on more constrained hardware platforms.

At step 540, a threshold for change detection is computed. The threshold can be derived from a desired false alarm probability, a configurable system parameter. The relationship between the threshold and the false alarm probability can be based on the known statistical properties of the squared Mahalanobis distance under the null hypothesis (i.e., when no change has occurred).

In embodiments, the sensor processing circuit 120 leverages a property of the computed Mahalanobis distance. When properly calculated using the inverted covariance matrix, the squared Mahalanobis distance follows a distribution independent of the CNH's variance (related to ambient noise levels). It depends only on the length of the CNH vector. This property allows for a robust change detection method that adapts to varying noise conditions.

Utilizing this property, the sensor processing circuit 120 can establish a threshold for change detection based on a prescribed False Alarm Probability (FAP). The FAP can be a configurable parameter that represents the acceptable rate of false change detections. The threshold can be uniquely derived from the desired FAP, taking advantage of the known distribution of the squared Mahalanobis distance under the null hypothesis (no change condition).

The system can detect significant changes in the scene when the squared Mahalanobis distance exceeds this threshold by setting the threshold. This approach provides a statistically sound method for distinguishing between normal variations due to noise and meaningful changes in the scene, with a controlled false alarm rate.

The threshold computation can be implemented in several ways, such as offline, real-time, or both. For example, in the offline approach, thresholds corresponding to various False Alarm Probabilities (FAPs) are pre-computed during the design stage and stored in the memory of the sensor processing circuit 120 or the host system 130. This method reduces real-time computational load and can be advantageous for resource-constrained systems. The sensor processing circuit 120 can then retrieve the appropriate pre-computed threshold based on the current operating conditions or user-specified FAP.

As another example, the threshold can be computed in real-time in systems with computational resources or those requiring adaptive behavior. The real-time approach allows for dynamic adjustment of the FAP based on current environmental conditions, application requirements, or user preferences. The choice between offline and real-time threshold computation can be made based on the specific needs of the application, available computational resources, and the desired level of adaptability in the scene change detection process.

At step 550, the sensor processing circuit 120 (it could be also 136 if the scene change detection is performed in the host) computes a per aggregator scene change indicator using the distance measurements from step 530 and the threshold determined in step 540. This step provides an output for each aggregate area.

In embodiments, the sensor processing circuit 120 compares the computed statistical distances for each aggregate area (as defined by the aggregation map from the spatial aggregation step) against the threshold from step 550. The comparison for every aggregate area can be performed independently. If the distance exceeds the threshold for a particular aggregate area, it indicates a meaningful change in that portion of the scene. The sensor processing circuit 120 generates an output for each comparison, resulting in a set of binary indicators (i.e., one for each aggregate area) signaling whether a change has been detected.

At step 560, the sensor processing circuit 120 computes a global scene change indicator using the distance measurements from step 530 and the threshold determined in step 540. This step provides a single output representing the overall change status across all or a subset of the aggregate areas.

In embodiments, using probabilistic rules, the sensor processing circuit 120 can derive a global SCI based on the various distance squares per aggregated zone. This approach allows for a more nuanced assessment of overall scene changes, considering the statistical significance of changes across multiple zones.

In embodiments, the global scene change indicator uses probabilistic rules based on the various distance squares per aggregated zone. This approach allows for a more nuanced assessment of overall scene changes compared to step 560, considering the statistical significance of changes across multiple zones.

In embodiments, the sensor processing circuit 120 compares the Mahalanobis distance measurements computed in step 530 for all or a selected subset of aggregate areas against the threshold established in step 540. Based on the comparison, the sensor processing circuit 120 applies a decision rule to determine the global change status.

This rule could take several forms. For example, it might consider the maximum distance across all areas and compare it to the threshold. Alternatively, it could calculate and compare the average distance to the threshold. Another approach might use a weighted sum of distances, where weights are assigned based on the importance or reliability of different areas.

The result of this comparison is a single binary output indicating whether a significant change has occurred in the overall scene. This global scene change indicator provides a high-level summary of change detection across the entire field of view, which can be useful for triggering subsequent actions or analyses.

The specific method for computing this global indicator can be configurable, allowing the system to be optimized for different applications or environmental conditions. This flexibility enables the system to adapt to various use cases, from simple presence detection to more complex scene analysis tasks.

Optionally, in step 580, the sensor processing circuit 120 may perform additional processing on the scene change indicators. This can include spatial or temporal filtering to reduce false positives or combining indicators from multiple zones to provide an overall scene change assessment.

Further, the system can compute preliminary scene change indicators even before the full temporal accumulation is completed. This early computation allows for rapid initial assessments of scene changes, which can be refined as more data becomes available through temporal accumulation.

At step 590, the sensor processing circuit 120 outputs the scene change indicators. These can be sent to the host system 130 for further processing or used to trigger specific actions, such as waking up a device from a low-power state.

Method 500 can be implemented as a continuous process, with new CNH and variance vectors processed for each new frame of sensor data. The method's configurable aspects, such as the false alarm probability and any additional filtering parameters, allow the system to be tuned for different applications and environmental conditions.

The disclosed approach offers several advantages over known solutions. Despite its theoretical complexity, it is simple to implement and requires low CPU usage. The system operates with very low power consumption and can run in a “Sleep mode” when the host device is off, only triggering an interrupt when a scene change is detected.

System integration is straightforward, as it can work alongside or replace existing Histogram Pipe (HIP) implementations. The approach is flexible, particularly for direct Compact Normalized Histogram (CNH) use. It allows easy configuration of maximum detectable distance and offers a customizable trade-off between spatial-temporal resolution and signal-to-noise ratio (SNR).

The Scene Change Indication (SCI) component is easily tunable through a single parameter: the desired False Alarm Probability. This simplifies the optimization process for different applications.

In embodiments, the proposed approach eliminates flicker issues and can be used to detect even very slow motions.

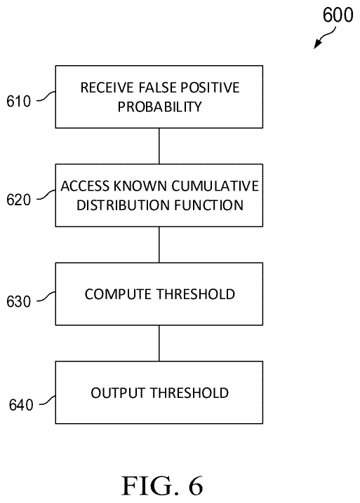

FIG. 6 illustrates an embodiment method 600 for computing a change detection threshold, which may be implemented as step 540 of method 500. Method 600 provides an example systematic approach for determining an appropriate threshold based on statistical properties and desired system performance.

It is noted that all steps outlined in the flow chart of method 500 are not necessarily required and can be optional. Further, changes to the arrangement of the steps, removal of one or more steps and path connections, and addition of steps and path connections are similarly contemplated.

At step 610, a required false positive probability is received as an input. The false positive probability represents the acceptable rate of false change detections and can be configured based on the specific requirements of the application or the desired sensitivity of the scene change detection process.

Step 620 involves accessing a known cumulative distribution function (CDF) for the distances without scene change. In embodiments of the disclosure, the CDF corresponds to the distribution of the squared Mahalanobis distances under the null hypothesis (i.e., when no change has occurred). The CDF can be derived from the theoretical properties of the Mahalanobis distance calculation and the characteristics of the Compact Normalized Histogram (CNH) data.

At step 630, the threshold is computed using the inputs from steps 610 and 620. The threshold computation can determine the threshold value by finding the point on the CDF corresponding to the complement of the required false positive probability (i.e., one minus the false positive probability).

Step 640 involves outputting the computed threshold. The threshold is used in the scene change indication process to determine whether the calculated statistical distances between current and previous CNH vectors indicate a significant change in the scene.

The process flow in method 600 can be implemented in various ways depending on system requirements and available resources. In embodiments, steps 620-640 can be performed offline during the system design phase, with pre-computed thresholds stored in memory for different false positive probabilities. This approach can reduce real-time computational load, which may benefit resource-constrained systems.

In embodiments with more computational resources or those requiring adaptive behavior, method 600 can be executed in real time. The real-time computation allows for dynamic threshold adjustment based on current operating conditions or user requirements.

By basing the threshold on a known statistical distribution and a specified false positive probability, method 600 enables the system to provide a controlled and tunable trade-off between sensitivity to changes and robustness against false alarms in the scene change indication process.

A first aspect relates to a system for processing direct time-of-flight (dToF) sensor data. The system comprising a dToF sensor comprising a light emitter and a photon detector array; a sensor processing circuit coupled to the dToF sensor and configured to acquire raw photon detection data from the dToF sensor, generate compact normalized histograms (CNH) and corresponding variance vectors from the raw photon detection data, compute statistical distances between CNH vectors from different time frames using the CNH vectors and their corresponding variance vectors, and determine scene change indicators based on the statistical distances; and a host system coupled to the sensor processing circuit and configured to receive the scene change indicators.

In a first implementation form of the system, according to the first aspect as such, the sensor processing circuit is further configured to normalize the raw histogram data; perform spatial aggregation of the normalized histogram data across configurable detector zones; and perform temporal accumulation of the spatially aggregated data over adjustable periods.

In a second implementation form of the system, according to the first aspect as such or any preceding implementation form of the first aspect, the sensor processing circuit is further configured to apply additional compaction techniques to the normalized data, including at least one of bin summation and clipping.

In a third implementation form of the system, according to the first aspect as such or any preceding implementation form of the first aspect, the sensor processing circuit is further configured to compute a covariance matrix based on the CNH vectors and corresponding variance vectors; perform matrix inversion on the covariance matrix; and compute the statistical distances using Mahalanobis distance calculations.

In a fourth implementation form of the system, according to the first aspect as such or any preceding implementation form of the first aspect, the sensor processing circuit is further configured to compute a threshold for change detection based on a configurable false alarm probability; and determine the scene change indicators by comparing the statistical distances to the threshold.

In a fifth implementation form of the system, according to the first aspect as such or any preceding implementation form of the first aspect, the sensor processing circuit is configured to operate in a low-power sleep mode and trigger an interrupt to the host system when a scene change is detected.

A second aspect relates to a method for generating compact normalized histograms (CNH) from direct time-of-flight (dToF) sensor data. The method comprising accessing raw histogram data from a dToF sensor; normalizing the raw histogram data; performing spatial aggregation of the normalized histogram data across configurable detector zones; performing temporal accumulation of the spatially aggregated data over adjustable periods; computing CNH vectors and corresponding variance vectors for each aggregated zone; and outputting the CNH vectors and variance vectors.

In a first implementation form of the method, according to the second aspect as such, performing spatial aggregation comprises defining an aggregation map that assigns unique identifiers to different groups of zones in a photon detector array; and combining histogram data from all zones sharing a same identifier.

In a second implementation form of the method, according to the second aspect as such or any preceding implementation form of the second aspect, performing temporal accumulation comprises combining data from multiple timing modes for each frame; and accumulating data over a configurable number of frames.

In a third implementation form of the method, according to the second aspect as such or any preceding implementation form of the second aspect, normalizing the raw histogram data comprises estimating and subtracting ambient light levels from each histogram bin; normalizing based on a number of effective single-photon avalanche diodes (SPADs) in each aggregated zone; and normalizing based on a duration of data acquisition for each timing mode.

In a fourth implementation form of the method, according to the second aspect as such or any preceding implementation form of the second aspect, the method further comprising applying additional compaction techniques to the normalized data, including at least one of bin summation, wherein adjacent time bins in a histogram are combined; and clipping, wherein an upper threshold is set for histogram bin values.

In a fifth implementation form of the method, according to the second aspect as such or any preceding implementation form of the second aspect, the method further comprising extracting additional features from the CNH vectors, including at least one of identifying start and end points of meaningful regions within the CNH; computing statistical measures such as kurtosis and skewness; and determining a number and locations of local maxima.

A third aspect relates to a method for implementing scene change indication using compact normalized histograms (CNH). The method comprising computing a covariance matrix based on CNH vectors and corresponding variance vectors for current and previous frames; performing matrix inversion on the covariance matrix; computing statistical distances between the CNH vectors of a current frame and a previous frame for each spatial zone; computing a threshold for change detection; computing per-aggregator scene change indicators by comparing the statistical distances to the threshold; and outputting the scene change indicators.

In a first implementation form of the method, according to the third aspect as such, computing the statistical distances comprises calculating Mahalanobis distances between the CNH vectors.

In a second implementation form of the method, according to the third aspect as such or any preceding implementation form of the third aspect, computing the threshold for change detection comprises receiving a required false positive probability as input; accessing a known cumulative distribution function (CDF) for distances when no scene change has occurred; and determining the threshold based on the CDF and the required false positive probability.

In a third implementation form of the method, according to the third aspect as such or any preceding implementation form of the third aspect, the method further comprising computing a global scene change indicator based on the statistical distances from multiple spatial zones.

In a fourth implementation form of the method, according to the third aspect as such or any preceding implementation form of the third aspect, the method further comprising performing additional processing on the scene change indicators, including at least one of spatial filtering to reduce false positives; temporal filtering to reduce false positives; and combining indicators from multiple zones to provide an overall scene change assessment.

In a fifth implementation form of the method, according to the third aspect as such or any preceding implementation form of the third aspect, the method further comprising computing preliminary scene change indicators before full temporal accumulation is completed.

In a sixth implementation form of the method, according to the third aspect as such or any preceding implementation form of the third aspect, the method is implemented as a continuous process with new CNH and variance vectors processed for each new frame of sensor data.

In a seventh implementation form of the method, according to the third aspect as such or any preceding implementation form of the third aspect, the method further comprising dynamically adjusting system parameters, comprising aggregation zone definitions, accumulation periods, detection thresholds, subbin aggregation, or a combination thereof.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A system for processing direct time-of-flight (dToF) sensor data, comprising:
a dToF sensor comprising a light emitter and a photon detector array;
a sensor processing circuit coupled to the dToF sensor and configured to:
acquire raw photon detection data from the dToF sensor,
generate compact normalized histograms (CNH) and corresponding variance vectors from the raw photon detection data,
compute statistical distances between CNH vectors from different time frames using the CNH vectors and their corresponding variance vectors, and
determine scene change indicators based on the statistical distances; and
a host system coupled to the sensor processing circuit and configured to receive the scene change indicators.

2. The system of claim 1, wherein the sensor processing circuit is further configured to:
generate a normalized histogram data from raw histogram data;
perform spatial aggregation of the normalized histogram data across configurable detector zones; and
perform temporal accumulation of the spatially aggregated data over adjustable periods.

3. The system of claim 2, wherein the sensor processing circuit is further configured to apply additional compaction techniques to the normalized histogram data, including at least one of bin summation and clipping.

4. The system of claim 1, wherein the sensor processing circuit is further configured to:
compute a covariance matrix based on the CNH vectors and corresponding variance vectors;
perform matrix inversion on the covariance matrix; and
compute the statistical distances using Mahalanobis distance calculations.

5. The system of claim 1, wherein the sensor processing circuit is further configured to:
compute a threshold for change detection based on a configurable false alarm probability; and
determine the scene change indicators by comparing the statistical distances to the threshold.

6. The system of claim 1, wherein the sensor processing circuit is configured to operate in a low-power sleep mode and trigger an interrupt to the host system when a scene change is detected.

7. The system of claim 1, wherein the raw photon detection data acquired by the sensor processing circuit comprises, for each detected photon, a timestamp indicating the arrival time of the photon relative to the emission of the light pulse and spatial information indicating which element of the photon detector array detected the photon.

8. A method for generating compact normalized histograms (CNH) from direct time-of-flight (dToF) sensor data, the method comprising:
accessing raw histogram data from a dToF sensor;
normalizing the raw histogram data;
performing spatial aggregation of the normalized histogram data across configurable detector zones;
performing temporal accumulation of the spatially aggregated data over adjustable periods;
computing CNH vectors and corresponding variance vectors for each aggregated zone; and
outputting the CNH vectors and variance vectors.

9. The method of claim 8, wherein performing spatial aggregation comprises:
defining an aggregation map that assigns unique identifiers to different groups of zones in a photon detector array; and
combining histogram data from all zones sharing a same identifier.

10. The method of claim 8, wherein performing temporal accumulation comprises:
combining data from multiple timing modes for each frame; and
accumulating data over a configurable number of frames.

11. The method of claim 8, wherein normalizing the raw histogram data comprises:
estimating and subtracting ambient light levels from each histogram bin;
normalizing based on a number of effective single-photon avalanche diodes (SPADs) in each aggregated zone; and
normalizing based on a duration of data acquisition for each timing mode.

12. The method of claim 8, further comprising applying additional compaction techniques to the normalized data, including at least one of:
bin summation, wherein adjacent time bins in a histogram are combined; and
clipping, wherein an upper threshold is set for histogram bin values.

13. The method of claim 8, further comprising extracting additional features from the CNH vectors, including at least one of:
identifying start and end points of meaningful regions within the CNH;
computing statistical measures such as kurtosis and skewness; and
determining a number and locations of local maxima.

14. The method of claim 8, wherein the raw histogram data accessed from the dToF sensor is derived from raw photon detection data comprising, for each detected photon, a timestamp indicating the arrival time of the photon relative to the emission of the light pulse and spatial information indicating which element of the photon detector array detected the photon.

15. A method for implementing scene change indication using compact normalized histograms (CNH), the method comprising:
computing a covariance matrix based on CNH vectors and corresponding variance vectors for current and previous frames;
performing matrix inversion on the covariance matrix;
computing statistical distances between the CNH vectors of a current frame and a previous frame for each spatial zone;
computing a threshold for change detection;
computing per-aggregator scene change indicators by comparing the statistical distances to the threshold; and
outputting the scene change indicators.

16. The method of claim 15, wherein computing the statistical distances comprises calculating Mahalanobis distances between the CNH vectors.

17. The method of claim 15, wherein computing the threshold for change detection comprises:
receiving a required false positive probability as input;
accessing a known cumulative distribution function (CDF) for distances when no scene change has occurred; and
determining the threshold based on the CDF and the required false positive probability.

18. The method of claim 15, further comprising computing a global scene change indicator based on the statistical distances from multiple spatial zones.

19. The method of claim 15, further comprising performing additional processing on the scene change indicators, including at least one of:
spatial filtering to reduce false positives;
temporal filtering to reduce false positives; and
combining indicators from multiple zones to provide an overall scene change assessment.

20. The method of claim 15, further comprising computing preliminary scene change indicators before full temporal accumulation is completed.

21. The method of claim 15, wherein the method is implemented as a continuous process with new CNH and variance vectors processed for each new frame of sensor data.

22. The method of claim 15, further comprising dynamically adjusting system parameters, comprising aggregation zone definitions, accumulation periods, detection thresholds, subbin aggregation, or a combination thereof.

23. The method of claim 15, wherein the CNH vectors are generated from raw photon detection data comprising, for each detected photon, a timestamp indicating the arrival time of the photon relative to the emission of the light pulse and spatial information indicating which element of the photon detector array detected the photon.

24. A direct time-of-flight (dToF) sensor device, comprising:
a light emitter configured to emit light pulses;
a photon detector array configured to detect reflected photons from the emitted light pulses; and
a sensor processing circuit coupled to the light emitter and the photon detector array, the sensor processing circuit configured to:
acquire raw photon detection data from the photon detector array,
generate normalized histogram data from the raw photon detection data,
perform spatial aggregation of the normalized histogram data across configurable detector zones,
perform temporal accumulation of the spatially aggregated data over adjustable periods,
generate compact normalized histograms (CNH) and corresponding variance vectors from the temporally accumulated data,
compute statistical distances between CNH vectors from different time frames using the CNH vectors and their corresponding variance vectors, and
determine scene change indicators based on the statistical distances.

25. The dToF sensor device of claim 21, wherein the sensor processing circuit is integrated on the same semiconductor die as the photon detector array, forming a single-chip dToF sensor.

26. The dToF sensor device of claim 21, wherein the raw photon detection data acquired by the sensor processing circuit comprises, for each detected photon, a timestamp indicating the arrival time of the photon relative to the emission of the light pulse and spatial information indicating which element of the photon detector array detected the photon.
